(19) United States
(12) Patent Application Publication
(10) Pub. No.: US 2025/0188361 A1
(43) Pub. Date: Jun. 12, 2025

(54) PROCESS AND SYSTEM TO CONVERT WASTE RECYCLABLE PLASTIC TO A HYDROCARBON STATE

(71) Applicant: Razor Waste Technology Inc., Regina (CA)

(72) Inventor: W. E. Groves, Meath Park (CA)

(21) Appl. No.: 18/533,643

(22) Filed: Dec. 8, 2023

(51) Int. Cl. C10G 1/10; C10G 9/08; F27D 3/14; F27D 3/16

(52) U.S. Cl. CPC C10G 1/10; C10G 9/08; F27D 3/14; F27D 3/16; C10G 2300/1003; C10G 2300/4012; C10G 2300/4043; C10G 2300/44; C10G 2300/70

(57) ABSTRACT

A closed loop system and process of converting waste recyclable plastic waste to a base hydrocarbon state is provided. The plastic waste is shredded, cleaned, dried, and melted such that in the melting process, an ignition sourced heating system and evaporation limit water content in the plastic waste. Prior to entering a pyrolysis reactor chamber, a light to medium petrochemical catalyst and a force is injected at a heating source such that molecular chains of the molten state liquid plastic are weakened, allowing the reactor to convert from a liquid state to a gaseous state in a shorter period. Vapor is joined from the reactor to a condenser and directed from the condenser to the designated areas.

### FIELD

The invention relates to a process and system for converting waste plastic into primary hydrocarbon, particularly into a gas, a liquid, and/or a solid state by subjecting the waste plastic to melting, catalyst, pyrolysis, vaporization, pressure, decentration, selective molecular bond destabilization, and selective condensation, whereby a final state of hydrocarbon is achieved. The system is highly efficient in conversion ratios, in the timely utilization of all said processes respectively, in precise ranging variances, to accommodate the molecular bond.

### BACKGROUND

With an increase in oil and gas production, there has been effectively an increase in the use of hydrocarbon-based products resulting in an increase in plastic development. The plastics are disposed in landfills, but may find their way into rivers and oceans where they can be environmentally harmful.

U.S. Pub. No. 2009/0062581A to Appel et al. discloses waste materials such as plastic waste being converted from raw stock into a highly refined, and higher priced end product such as hydrocarbon distillates. For example, diesel, gasoline, ethanol, and other usable end products. Similarly, WO 2005/087897 to Baker discloses plastic being used as a raw base stock and processed into a higher end product that has a high-end value than the waste being processed.

U.S. Pub. No. 2010/0018116 to Mahjoob discloses a system for converting a solid fuel into a fuel including a pyrolytic unit for producing a pyro gas comprising hydrocarbons, a synthesis gas production unit for converting the pyro gas into a synthesis gas comprising a mixture of hydrogen and carbon monoxide, and a gas-to-liquid unit for converting the synthesis gas into a fuel.

U.S. Pub. No. 2012/0261247 to McNamara et al. discloses a process for treating waste plastics material to provide at least one on-specification fuel product. Plastics material is melted and then pyrolyzed in an oxygen-free atmosphere to provide pyrolysis gases. The pyrolysis gases are brought into contact with plates in a contactor vessel so that some long chain gas components condense and return to be further pyrolyzed to achieve thermal degradation. Short chain gas components exit the contactor in gaseous form and proceed to distillation to provide one or more on-specification fuel products. A pipe directly links the pyrolysis chamber to the contactor, suitable for conveying upwardly-moving pyrolysis gases and downwardly-flowing long-chain liquid for thermal degradation

U.S. Pub. No. 2017/0073584 to Bordynuick discloses a system and process for converting plastics and other heavy hydrocarbon solids into retail petroleum products. The plastics are processed by melting, pyrolysis, vaporization, and selective condensation, whereby final in-spec petroleum products are produced. The system provides a reactor for subjecting the plastics to pyrolysis and cracking hydrocarbons in the plastics to produce a plastics vapor comprising hydrocarbon substituents; one or more separation vessels for separating the plastics vapor into hydrocarbon substituents based on boiling points of the hydrocarbon substituents; one or more condensers for condensing the hydrocarbon substituents into one or more petroleum products; and means for collecting the one or more petroleum products. Fuels generated during the process can be recycled for use upstream in the process.

United Kingdom Pub. No. GB 2158089 to Szu-Jen discloses a process of treating waste plastics, comprising the step (a) melting the waste plastics e.g. in heavy oil; (b) heating the melt to produce gas; (c) cooling the gas to approximately room temperature and collecting the oily liquid condensed during the cooling of gas; and (d) fractionally distilling the oily liquid received from step (c) to obtain fuel oil of various boiling points.

Chinese Pub. No. 101050373 to Yan discloses a process for refining oil from waste plastics. The process comprises: extruding waste plastics, sending molten waste plastics into a moving bed pyrolysis kettle, mixing with high-temperature sand catalyst, pyrolyzing instantly to obtain mixed oil gases, introducing into a kettle-type flash evaporation fluidized bed reactor, further catalytically pyrolyzing, ascending the generated gas and the mixed oil gases to the top of the kettle-type flash evaporation fluidized bed reactor, reforming with a molecular sieve catalyst at the top, condensing, and introducing into a rectification apparatus. Wastes in the production are adhered to the used sand catalyst, and then sent to a regeneration furnace. The wastes can be combusted, which can save energy. The sand with surface wastes combusted can be recycled.

JP 07331251 to Machitori et al. discloses a pyrolyzing and liquefying apparatus capable of producing useful regenerated oil without using a catalyst and pyrolyzing and liquefying method. The apparatus has a condenser connected to a gas outlet of a pyrolysis tank and a gas component gasified at a temperature higher than a condensed temperature is cooled and liquefied without passing through the condenser and returned to a pyrolysis tank and refluxed. The reflux is repeated between the pyrolysis tank and the condenser. Thereby, the plastic molecule having long linkage of hydrocarbons is cut into small chains to convert the molecule to low-molecular weight hydrocarbon. Since the gas component gasified at higher temperature than the condensed temperature is not passed through the condenser, the gas component contains a low-boiling point component in large amounts and a regenerated oil component not causing solidification at <=0° C. can be taken out without using any catalyst.

Japanese Pub. No. 2003301184 to Yamada et al. discloses a method for pyrolytically reducing plastic wastes to oil wherein agglomeration of residues in a pyrolyzing furnace can be prevented, the gasifying rate of high boiling-point refluxing liquid components can be increased, and the energy consumed for heating can be reduced. Plastic wastes are pyrolytically gasified in the pyrolyzing furnace heated by a heater. The pyrolyzed gas thus formed is cooled and condensed in a first cooler to liquefy high boiling-point components. Low boiling-point gas components are separated from the high boiling-point liquid components in a refluxing vessel. The low boiling-point gas components separated in the refluxing vessel are subjected to cooling/condensing in a second cooler located downstream of the refluxing vessel to form an oil. The high boiling-point components are gasified through decomposition in a refluxed liquid decomposition/gasification furnace located between the pyrolyzing furnace and the refluxing vessel, and then refluxed to the first cooler.

Japanese Pub. No. 2009209278 to Kobayashi et al. discloses a method for converting waste plastics to oil, enabling proper fractionation to be accomplished, and enabling the relevant system to be miniaturized and oil production cost to be reduced, and to provide the system for converting waste plastics to oil. The system includes a pyrolysis tank for heating and pyrolyzing waste plastics, a condenser for oil stock liquid for cooling an oil component vaporized in the pyrolysis tank to condense it to an oil stock liquid, a plurality of heating tanks for fractionation connected in series so that the oil stock liquids are successively introduced thereinto and heated with successive temperature differences and functioning to vaporize the oil stock liquids to the respective necessary compositions, respective condensers for fractionation connected to each of the heating tanks and functioning to cool vaporized oils and condense them so as to give respective oils of necessary compositions, and respective reservoir tanks connected to each of the condensers and intended to reserve the respective oils of necessary compositions.

### SUMMARY

According to an aspect, there is a system for converting a solid plastic to a base hydrocarbon. The system may comprise: a preheating chamber transforming the solid plastic into a liquid plastic; one or more injectors providing a focused energy release into the liquid plastic to break molecular bonds in the liquid plastic, wherein the focused energy release comprises a catalyst, the liquid plastic flowing by the one or more injectors; a pyrolytic reactor receiving the liquid plastic from the preheating chamber and further heating the liquid plastic to form the base hydrocarbon; and a condenser receiving the base hydrocarbon and condensing the base hydrocarbon into at least one of: a light hydrocarbon liquid, a heavy hydrocarbon, and a natural gas. The injector(s) may be directed at a focal refractor within a flow of the liquid plastic. The focal refractor may be centrally located within the flow of the liquid plastic. The focal refractor may comprise a plurality of fins extending radially from a central hub. The central hub may comprise a reflective dish. The focal refractor may transform a laminar flow of the liquid plastic into a turbulent flow. The injector(s) may be at an angle of between 8-degrees and 15-degrees in relation to a flow of the liquid plastic. The catalyst may comprise a light liquid hydrocarbon selected from any one of: ethanol, methanol, naphtha, and light oil. At least a portion of the catalyst may be from the base hydrocarbon.

According to an aspect, there is provided a method for converting a solid plastic to a base hydrocarbon. The method may comprise: transforming the solid plastic into a liquid plastic by heat; flowing the liquid plastic past at least one focused energy release to break molecular bonds in the liquid plastic, wherein the focused energy release comprises a catalyst; heating the liquid plastic in a pyrolytic reactor to form the base hydrocarbon; and condensing the base hydrocarbon into at least one of: a light hydrocarbon liquid, a heavy hydrocarbon, and a natural gas. The method may further comprise: directing the at least one focused energy release at a focal refractor within the flow of the liquid plastic. The focal refractor may be centrally located within the flow of the liquid plastic. The focal refractor may comprise a plurality of fins extending radially from a central hub. The central hub may comprise a reflective dish. The method may further comprise transforming a laminar flow of the liquid plastic into a turbulent flow. The at least one injector may be at an angle of between 8-degrees and 15-degrees in relation to a flow of the liquid plastic. The catalyst may comprise a light liquid hydrocarbon selected from any one of: ethanol, methanol, naphtha, and light oil. At least a portion of the catalyst may be from the base hydrocarbon.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 illustrates a process flow chart illustrating a conversion process of waste recyclable plastic to baser hydrocarbon states;

FIG. 2 illustrates a side view of a linear cylindrical tubular member that enables focused energized employment within a flow of liquid plastic;

FIG. 3 illustrates a cross-sectional view of the linear cylindrical tubular member where a catalyst is introduced to produce a high energy transfer for an expedited conversion through molecular deconstruction of the liquid plastic;

FIG. 4 illustrates a cross-sectional view of an energized ducting and focal, coupled with an embedded stationery mixing apparatus;

FIG. 5 illustrates a front view of the embedded stationery mixing apparatus;

FIG. 6 illustrates cross-sectional view of an injector for introducing the catalyst into the liquid plastic within the tubular member; and

FIG. 7 illustrates a cross-sectional view of a rotary valve for providing the catalyst to the injector.

### DETAILED DESCRIPTION

In this application, the description and illustrations demonstrate the utilization but are not limited to municipal, industrial, rural, urban, or other form of state or government bodies responsible for the collection, recycling, and or disposal of solid waste, recyclable plastic. Components within the process utilize a method for attaining high heat values, the heating component in this heat energy is considered, but not limited to natural gas, or methane, butane (C₄H₈), or a vapor or gaseous hydrocarbon, that may be used in higher heating applications.

The process described within is to encapsulate a process and a system that converts a base waste or recyclable plastic, being plastic 1-7, which are classified under the recycling governing program. In the processes and systems that are being discussed in this process, all forms of recyclable plastic may be considered, whereas in other processes, very specific plastics, like plastic 1, or 2, which are Plastic 1 PET “polyethylene terephthalate” and Plastic 2 HDPE “high density polyethylene” are a raw product, due to higher carbon and hydrogen bonds to collate into an easier convertible raw product for a more consistent end raw product, with a higher end value, such as diesel.

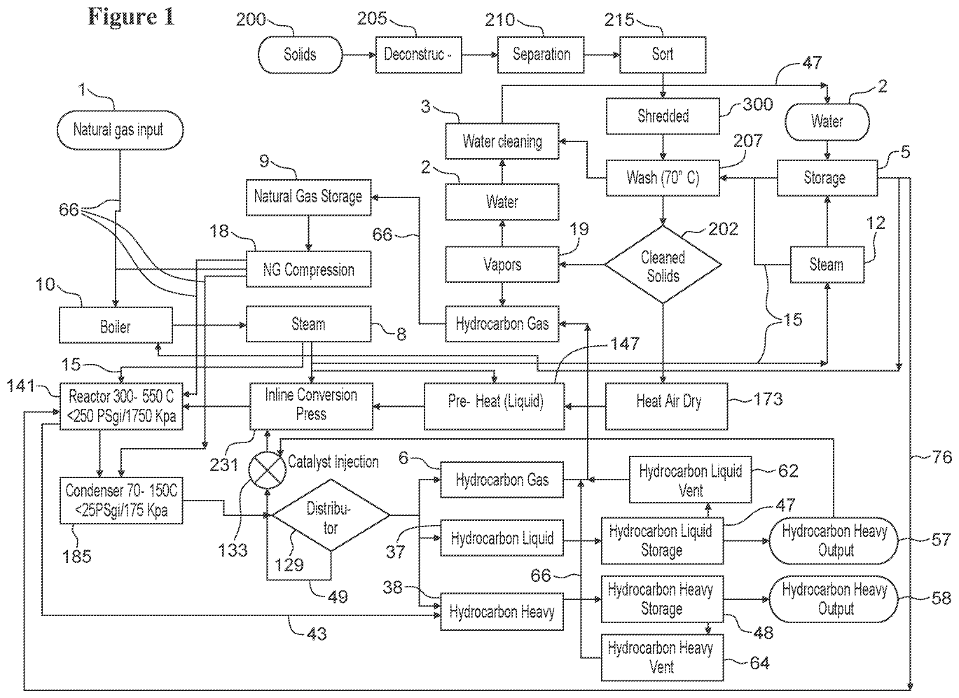

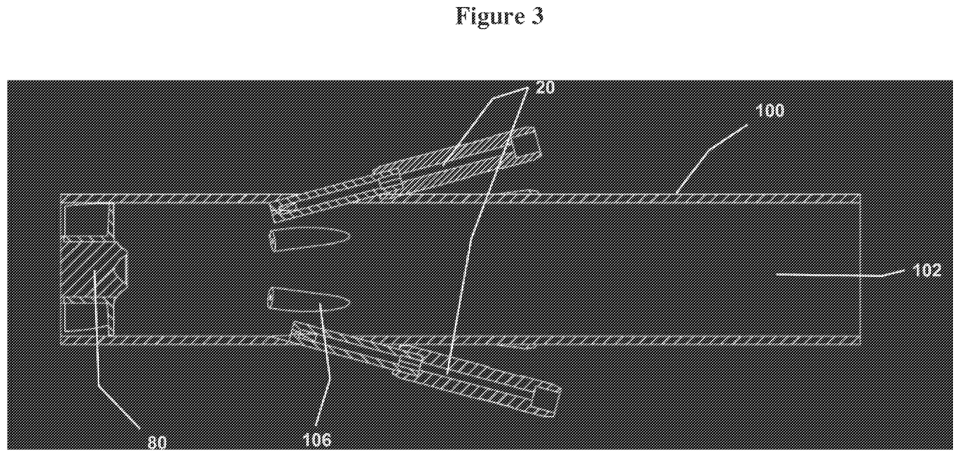

The process and system describe herein and illustrated in FIGS. 1 to 7 demonstrate an ability to create a focused energy system to cause a molecular deterioration that may allow for a more efficient capacity to vaporize recyclable plastic from a liquid phase into a vapor phase. The focused energy system may break and reform molecular bonds into a different hydrocarbon states, but is not limited to, comprising of a gaseous, light and heavy liquid hydrocarbon, namely natural gas, oil, and bitumen/asphaltenes.

The waste, recycled plastic may be collected and sorted from a receiver, typically known as a recycling receiver, such as specified bins, drop off points, collection bins, and/or other urban and rural aspect of recycling waste recovery systems. Recycling recovery systems may comprise multiple solid wastes that are then taken to a single-source Material Recycling Facility (MRF), in which sorting of the solids is completed either mechanically, autonomously, and/or by manual labor which may be taxing since the volumes in urban centers may be high. MRFs may process paper, cardboard, plastic, metals, and/or glass. Additionally, there may be precise or single forms of solid waste recycling that comprise a target removal for recycling. An example of this is found in Europe, where sanitary napkins, diapers and other possible human contaminated source recycling can be found and recycled from the landfill to ensure the full reduction of recycling from mainstream solid waste disposal.

The raw recyclable plastic product may be shredded and compressed for ease of transport, in other cases the raw recyclable plastic is compressed to maintain size limitations due to spacing confines as well as to ensure that the raw recyclable plastics are capable of being transported easier than in an uncompressed state. In this compressed or shredded form, the structure created is considered a bale of the recyclable plastic. This bale may be, but not limited to, a rectangular form having a width, a height, and a length of 3 feet (0.9104 meter) by 3 feet (0.9104 meter) by 5 feet (1.5424 meter). The raw recyclable plastic may be condensed utilizing hydraulic pressure to compress the bale into the rectangular form. Once the bale is fully formed and contains an appropriate amount of recyclable plastic, the bale may be contained herein by metal strapping, bale wire, plastic strapping, plastic wrapping, plastic mesh wrapping, metal or plastic string, and/or a band to maintain the pressure on the baled recyclable plastic.

Once the recyclable plastic is separated through the MRF, baled and the ready for removal from the MRF, the baled recyclable plastic is then delivered as a solid plastic 200 to a facility for conversion into a primary hydrocarbon. The bale may be enclosed and broken down or deconstructed 205 through release of the wire, string, or other containment system that was employed on the bale by the MRF. In the process of deconstruction 205, the solid plastic 200 may be metered into the conversion processes. In this deconstruction 205, it is determined that the bale would remove any outer securing mechanisms. A released pressure of the bale may then initialize a conversion process. The released bale may be contained in a container, such as a five-sided container, or the like and may further supplement a process or system that may decompress the released bale from an original compressed state. The feed or supply to the conversion process may be consistent in size, weight, and/or height such that the recyclable plastic may be returned to the original uncompressed state.

A feed or supply may include a separation (or extraction) system 210 to extract at least a portion of the released bale and may include a chain, a screw, air, or other form of movement of the portion from the container. In some aspects, the extracted portion may be pre-sorted 215 into different types of recyclable plastics and/or to remove contamination. The pre-sorting may include but is not limited to, mechanical sorting, automated sorting, electromagnetic sorting, and/or optical sorting. Due to the reduced density of the recyclable plastic compared to water, a float/sink process may be used to remove higher density substances that may not be retrieved by the separation process and retrieved through magnetic or electromagnetic sources. In this capacity, denser density objects such as metal, and other possible contamination may be mechanically removed and processed and recycled as required. The metals that may fail to be removed by magnetic force, may include, but are not limited to, money, some stainless steels, aluminum, copper, brass, and so forth. The process of removal of the unwanted sorted materials may ensure that the hydrocarbon liquid 37 or heavy liquid 38 may contain a higher valued and pure hydrocarbon, within limited contamination as described herein.

The extracted portion of the plastic may then be dilated or shredded 300 to a specified size to allow for varied utilization of the shredded plastic in the conversion process. The specified size may be in a range of about 0.25-inch to about 0.375-inch (about 0.625-cm to about 0.9525-cm), but is not limited to these sizes. For example the specified size may be greater than 0.001-inch. The consistency in size provides a uniform heat application in the conversion process. Temperatures throughout the conversion process may be in the range of about 60° C. to about 550° C. as described in further detail herein.

Following the shredding process 300, conveyance from the shredder 300 to the wash system 207 may be facilitated through a conveyor system. The shredded plastic on the conveyor may be monitored electronically to ensure that a consistent amount of shredded plastic enters the cleaning system 207. Any contamination of the shredded plastic may be processed or sterilized with a high-heat and/or high-pressure wash system 207 in order to provide a quality end product. Possible contaminants within the shredded plastic may be metal, paper, food contamination, refuse, dirt, and other possible contaminants. The high-heat, high-pressure wash system 207 may include a steam-assisted heating system 12 that injects water 2 from a storage tank 5.

Within the cleaning process 207, heat is applied to the water sourced, to a temperature of approximately 70° C. (158° F.), in which the shredded plastic may remain in the clean washing process 207, for a period of greater than 3-minutes of which any biological contamination may be sterilized through the heat process. Application of pressurized jetted and directed cleaning 207 of the shredded plastic 200 may have a pressure, not limited to, but within a range of about 1500-PSIG to about 5000-PSIG (10.5-MPa to 35-MPa). Cleaned plastic 202 may emerge from the washing system 207. In some aspects, the cleaned plastic 202 may be electronically monitored and if not clean, the shredded plastic may be returned to the cleaning process 207. In some aspect, a detection of unclean plastic may trigger a temperature change and/or a pressure change in the cleaning system 207.

The wash system 207 may include a hopper-style inlet into a wash tank, received from a conveyor directed from the shredder process 300. In this capacity, the inlet may be limited to a maximum of about 130-lbs to about 200-lbs (60-kg to 90-kg) of the shredded plastic through the wash system 207 on a per minute basis. In some aspect, the temperature of the water 2 used in the wash system 207 may be varied from about 60° C. to about 70° C. (140° F. to 160° F.). In this capacity, any biological contamination may be neutralized. The wash system 207 may process approximately 600-kg to approximately 900-kg (1300-lbs to 2000-lbs) of the shredded plastic at any given length of time with a washing time of approximately 10-minutes to 14-minutes. In this capacity, any biological contamination is neutralized, as well as being able to ensure appropriate cleaning capabilities. The cleaned plastic may be more pliable following cleaning but may retain its primary entry shape prior to being dried to remove 90-95% of the moisture.

As the injected water 2 is recycled, the injected water 2 may accumulate particulates that may or may not be disassociated into the water. The injected water may be filtered and cleaned through a closed loop water cleaning system 3. Most particulate may remain in a solid state and be able to be physically removed from the water source utilizing primary water waste cleaning techniques similar to those used within such operations as drilling operations, distilleries, mining, urban and other such wastewater. These industries may use 100% recycled fluids.

The closed-loop water 2 may be cleaned through a mechanical process. The water cleaning system 3 may comprise a 3 to 4 Xscreen shaker, which removes primary large solids. The large solids may be primarily biological in nature and are removed and taken for compost. Following the screen shaker, a de-sander or de-silter in line system may be used to remove heavier and mid-range solids. These mid-range solids may also be biological matter that is removed and composted. Following the de-sander or de-silter, the cleaning system 3 may subject the closed-loop water 2 to a centrifugal force by centrifuge to remove any remaining fine matter. To polish the water 2, a 1-micron filter systems with multiple banks along with an activated charcoal carbon filter may be used. Water pressure in the cleaning system 3 may be at approximately 4,000-PSI to approximately 6,000-PSI (28-MPa to 42-MPa). Steam may be injected directly and indirectly into the water 2 to maintain a temperature of about 60° C. to about 70° C. (140° F. to 160° F.). The water cleaning system 3 may be able to process approximately 500-liters/minute (132-US gallon/minute).

Once the clean plastic 202 exits the wash system 207, the clean plastic 202 may be separated and agitated so as to physically remove moisture that may be retained on the outside of the clean plastic 202. Conveyance from the wash system 207 may be accomplished by an enclosed conveyor and the clean plastic 202 may be exposed to a high-speed, high-volume of heated air from a drying unit 173 that utilizes primary heated air to ensure that the water content of the cleaned plastic is reduced to about 1% to about 3%. The heated air may efficiently and effectively remove water droplets off the sterile plastic. The dried plastic may be conveyed to a storage containment to control an appropriate volume of dried sterile plastic entering a reactor 141 as described in further detail below.

During the cleaning process 207 and/or the drying process 173, the plastic may produce vapors 19, such as water vapor and/or hydrocarbon gas. Capture of the vapors 19, through a vented hood that pulls all free radical vapors from the wash system 207. In some aspects, the vapors 19 may be extracted and transferred to a condenser, which may separate the water 2 from the hydrocarbon gas 66. The water 2 may be returned for re-use in the water cleaning system 3. The hydrocarbon gas 66 may proceed to a natural gas storage 9 via a pipe with one-way valving, which may be subsequently compressed using a compressor 18 and provided to the reactor 141 and/or the boiler 10 for combustion or to a condenser 185 as described in further detail below. This process occurs in a closed loop where no water 2 or hydrocarbon gas 66 escapes the closed loop washing system 2, 5, 207, 202, 19, 2, 3, 47.

The dried plastic is then preheated 147, by steam imbibement throughout a mixing process within an enclosed conveyor, such as an auger. During the preheating process 147, the dried plastic converts into a liquid plastic though heating and mixing to ensure a full liquid state is achieved. Any remaining water on the dried plastic is evaporated, as a preheat temperature within this auger may be between about 200° C. to about 240° C. (392° F. to 464° F.). Although in some instances, the auger may be heated to greater than approximately 100° C. (212° F.) and in other aspects may be heated to a temperature of approximately 200° C. (392° F.).

When the dried plastic fully becomes the liquid plastic, the liquid plastic may be able to be pumped from the auger into a sealed tubular member 100 and heated to greater than about 250° C. (482° F.). The sealed and preheated tubular member 100 may be joined from the pre-heat auger 147 to the pyrolysis reactor 141, such that the flow is maintained on a constant velocity of approximately 130-lbs to approximately 200-lbs (60-kg to 90-kg) per minute of phased liquid plastic flow 102 through the tubular member 100.

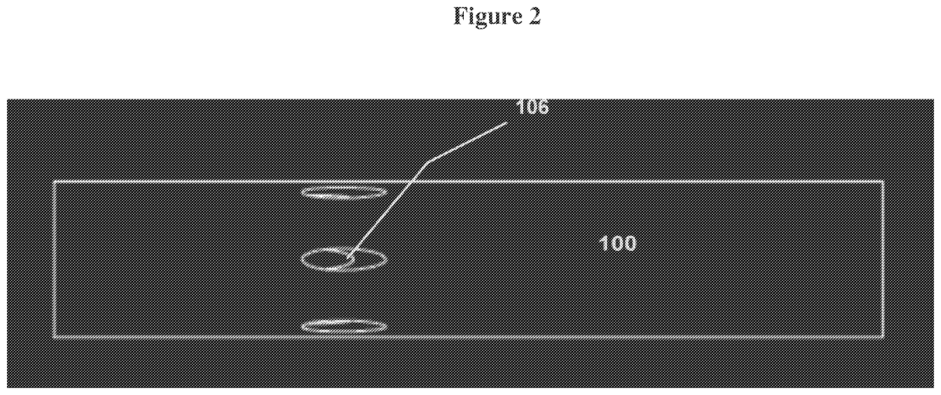

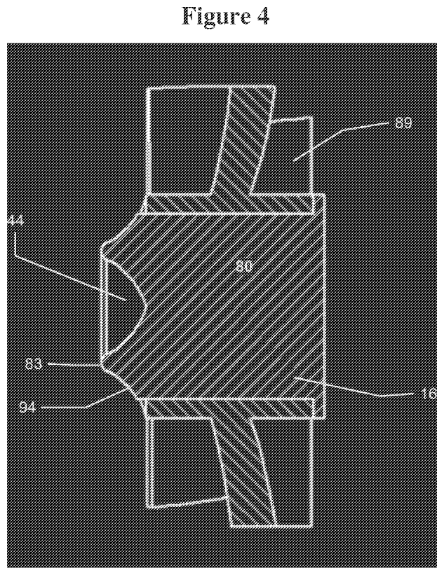

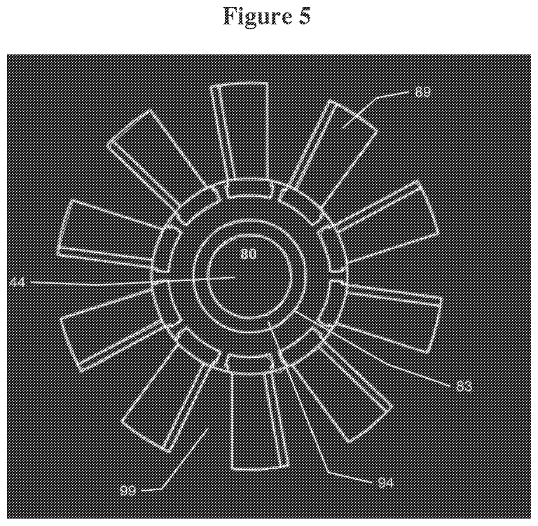

As the liquid plastic flows through the tubular member 100, a phase converter induction 231, shown particularly in FIGS. 2-5, may be implemented approximately 2-m (6.2-ft) from a pyrolysis reaction chamber 141 (e.g. reactor). The phase converter induction 231 may comprise at least one injection site 106 directed towards a stationary mixing focal refractor 80, shown particularly in FIGS. 4 and 5. The injection sites 106 may be coupled to one or more injectors 20 that may inject a light catalyst into the phased liquid plastic at an angle. The angular ascension of the injection sites 106 within the tubular member 100 may have an ascension angle of about 6-degrees to 18-degrees from a center axis of the tubular member 100. In some aspects, the specific angle may be less than about 15-degrees offset from a center plane of a midline of the tubular transference member 100, bearing an angular decent from an outer portion of the tubular member 100 to a center point member of the solid end point 16.

In this aspect, six injection sites 106 may be present around a circumference of the tubular member 100. The number of injection sites 106 may be determined by a diameter of the tubular member 100 in that backpressures in the tubular member 100 are limited. The number of injection sites 106 may generally be determined by an inner diameter of the tubular member 100 divided by 1.32 and rounded to the nearest single digit. The number of injection sites 106 may be between 4 to 20 such entry points, dependent on the outer diameter size of the tubular member 100. The pressure within the tubular member 100 may be regulated through vapor escape through a pressure release system. The tubular pressure may be about 250-PSIG (1750 kPa).

A position and/or angle of the injection sites 106 may assist to direct the phased liquid plastic into a convergence in a central position 44, with a counter-clock wise rotation, due to angular positioning of the finned apparatus 80 within. As such, the injection sites 106 may be angled and directed towards a central point on the focal refractor 80. The injection sites 106 in combination with the focal refractor 80 may create a slight cavitational force or A forces on the phased liquid plastic.

Turning to FIGS. 4 and 5, the focal refractor 80 may facilitate intimate mixing of the liquid phase plastic with the light catalyst without using other mechanical means. The focal refractor 80 converts the laminar flow into a turbulent flow. The focal refractor 80 may be stationary within the tubular member 100. The refractor 80 comprises a central solid body 16 surrounded by a finned extrusion 89 having a plurality of fins and a plurality of ports 99 therebetween. The flow through the ports 99 may co-mingled resulting in circular dispersion across the fins of the refractor 80. In this aspect, the finned extrusion 89 has ten fins, but other aspects may have more or less fins in the range of six fins to twenty fins. The number of fins may be dependent on a size of the tubular member 100 and/or the flow of the liquid plastic therethrough. The central solid body 16 may comprise a reflective dish 44 having a generally convex shape directed towards the flow of the liquid plastic. The reflective dish 44 may be encompassed by a ring 83, which creates a reflective face coupled with an eased radial section 94.

The reflective dish 44 may contain, divert, and focus a laminar-to-turbulent flow of the liquid plastic across the convoluted fins 89 to create a complete mixing as well as finalize an energized pressure release within the liquid plastic in order to expedite a phase state conversion of the liquid plastic into a vapor hydrocarbon within the reactor 141. The phase state conversion may result in the liquid plastic to break into base hydrocarbons. The energized pressure release may occur in sequential and/or patterned fashion that allows for direct flow patterns within the reactor 141.

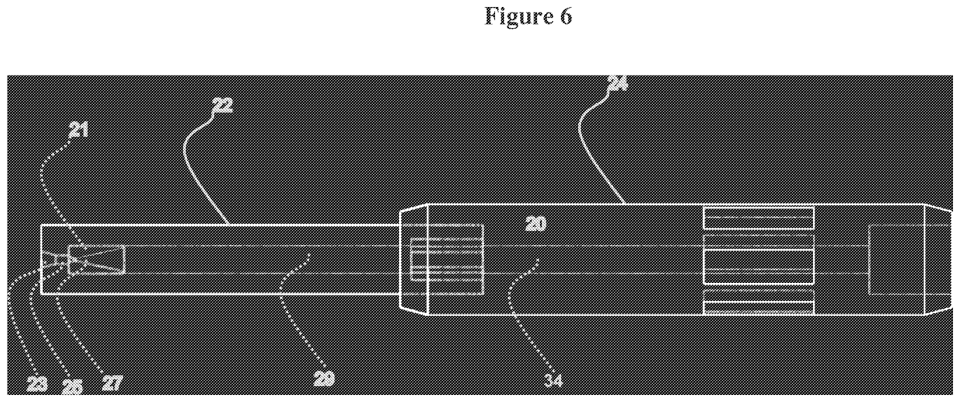

Turning to FIG. 6, a catalyst injection system 133 may directly inject a light catalyst via the injectors 20 into the phased liquid plastic by a pressure created from a pressure pump, such as a piston, reciprocation, turbine, or other assisted pressurized system for liquid systems. The light catalyst may be any light hydrocarbon-based catalyst, of which may include, but not limited to, a recycled light hydrocarbon in liquid phase that has been condensed for the purpose of dissolution of the liquid plastic. The light catalyst may comprise ethanol, methanol, naphtha, butane, and other such items derived from hydrocarbons. The pressurized catalyst injection may occur at high pressures such as a pressure point of about 35-MPa to about 70-MPa (5-PSI to 10,000-PSI).

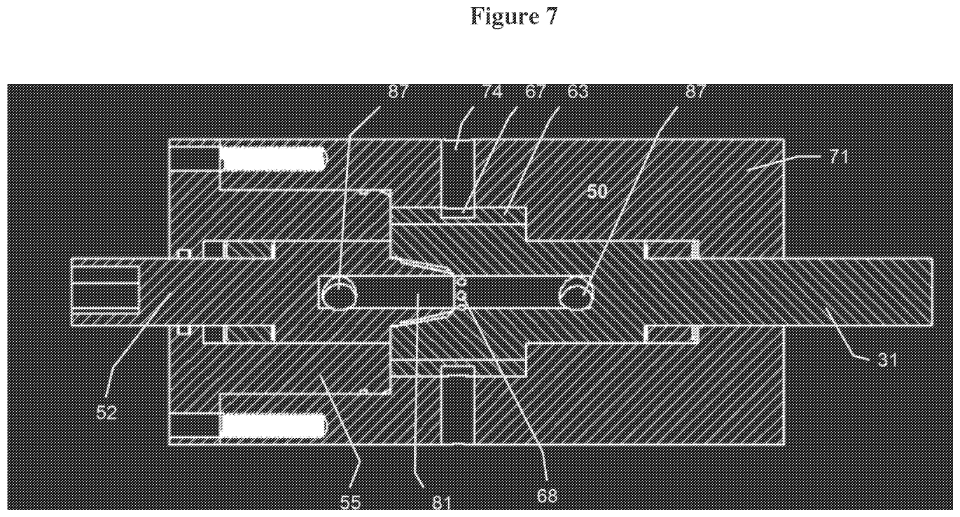

The injector 20 comprises a generally cylindrical shape with a valve end and a focused injection outlet end. The focused injection outlet end couples to the injection site 106 whereas the valve end couples with the valve depicted in FIG. 7. Each of the injection sites 106 may be threaded to receive a corresponding threading along a portion 22 of the injector 20. The injector 20 may reduce in internal diameter from the valve end towards the focused outlet end. The focused outlet end may comprise a focused outlet 27 that creates a restriction 27 of up to 90%. The restriction 27 may limit a total amount of catalyst injected at the size 106 and may be selected based on a particle size of the catalyst. A size of the restriction 27 may be determined from a molecular size of the catalyst in inches multiplied by 14.236198. This number is not limited to 14.236198 and can be adjusted for the flow and/or pressure of the liquid plastic past the injection points 106. A ratio of 1:0.04% with a variance of multitude in ratio of up to 3 times may enhance the molecular deconstruction of the liquid plastic through molecular bond dissolution. The pressure increases at the restriction 27 thereby increasing a velocity of the light catalyst as it passes a conveyance point 25 and out the outlet 23. Nozzle shaping of the restriction 27, conveyance point 25, and the outlet 23 may also be used to adjust the amount of the catalyst to enhance the overall mixing performance. The focused and accelerated release into the injection site 106 may generate an energy increase directed and focused on the refractor 80 as previously described.

The directed pressurized energy release may create a heightened state of energy at the outlet 23, and may allow for an integrated acceleration of the flow path, that creates a secondary shock wave within. This shock wave in some forms and terms may be considered cavitational in nature, but since the cavitational force is founded and assumed within a short radial fashion of release from the outlet 23, would be within the confines of the inline conversion 231 tubular member 100. The pressurized energy release that occurs within the inline conversion chamber may be self-directed through the placement of the injectors 20, which are aligned and directed along a vectored and angled ascension 106 to the primary interior of the tubular member 100.

The pressurized catalyst acceleration release transmits along a primary axis of the tubular member 100 and into the pyrolysis reactor 141. A reflection and refraction of the pressurized energy release may occur within the pyrolysis chamber 141 up to, but not limited to, 50 times reflecting from a reactor boundary to a secondary boundary. Obstructions may be added to an interior of the reaction chamber 141 to cause ripple effects, which can help to create secondary and multiplexed vectored cross ripples. The ripple effect within the reactor 141 can create a peristaltic wave form that may enhance an overall mixture and utilization of the light catalyst. Within the reactor 141, destructive waves also occur in which molecular bond cohesion may be dramatically reduced by up to 80-85%.

Turning to FIG. 7, a valve 50 may provide the pressurized catalyst to the injectors 20. According to some aspects, one or more injection lines may connect the injectors 20 from the valves 50. The injection lines may be structured tubular members, flexible pressure conduit, lines, pipes, or other possible conduits that enable pressurized fluid passage to occur. The valve may comprise two outer bodies 55, 71 coupled together with one or more bolts. Within the outer body 71 may be a primary shaft 31 and within the outer body 55, may be a secondary shaft 52; both of which are aligned with an axis of the outer bodies 55, 71. The primary shaft 31 and the secondary shaft 52 may be coupled together such that a rotational force on one of the shafts 31, 52 rotates the shafts 31, 52 in unison. The rotational force may be provided by an electric motor and rotating the shafts 31, 52 at between about 100-rpm to 3600-rpm. In this aspect, the rotational force is provided to the primary shaft 31 and translated to the secondary shaft 52. The shafts 31, 52 may be coupled together via a threaded member rated for pressure as well as force requirements for the valve 50. The rotation may be in a clockwise or counterclockwise direction.

The shafts 31, 52 may define a space therebetween generally cylindrical in shape. The cylindrical space 81 may couple at least two pressure inlets 87 for receiving the pressurized catalyst within the cylindrical space 81. As the shafts 31, 52 rotate, the pressurized catalyst within the cylindrical space 81 may be released from one or more exterior release outlets 68 when the release outlets 68 align with one or more minor release chambers 63 of which one or more resonance chambers 67, 74 capsulate a focused energy release to the injectors 20. The release chambers 63 in combination with the resonance chambers 67, 74 provide a more consistent pressure energy release. The resonance chambers 67, 74 may be coupled to one or more of the injectors 20. As this energized pressure release travels along the resonance chambers 67, 74, there is an amplification and reflection within the resonance chambers 67, 74.

In use, the valve 50 may alternate the pressure injected injection port 106 to injection port 106, and thusly may alternate in a specific or unspecific manner. For example, port 1 shutting off as ports 2-6 are injecting, or ports 2 and 4 are injecting, while ports 1, 3, 5, 6 are not. The pulsed medium may create a secondary pressure waves within the liquid plastic within the confined tubular member 100. In the pulsed state, pressure wave articulation through the tubular member 100, a cross-wave pattern of pressure may be produced across the injection points 106. The cross-wave pattern may reduce molecular cohesion due to heat increased, a vibrational injected force, a cavitational force, and a cross-sectioned force used in wave dispersion patterns as a pressure wave extrusion from the point of origin of the contact of injected pressure to the laminar flow conducted through the primary source tubular member 100.

The pulsed injection of the light catalyst may be linked to the input volumes of the catalyst amount injected and may be delivered by the valve 50 that allows for complete injectional flow shut off at the source of injection, which may include a regulated injection application through solenoid, primary source feed shut off, or other apparatus that positions the injection of the light catalyst at the appropriate time, and volumetric amount. The based pulsation on a hertz basis may be at approximately 15-Hz to approximately 36-Hz, which equates to 15 to 36 pulses of injection per second. The speed of pulsation is directly proportional to a frequency and amplitude of the pulse wave created at source. As such directed inverse calculations indicate that a ½ wave propagation of approximately 1500-ft at 12-Hz, with a directed pulse pressure of 35-MPa (5,000-PSI) allowing for a true wave penetration and reciprocation of wave inference within the pyrolysis reactor chamber 141 of length at 3-m (9.6-ft) thusly a rounded penetration of a single pulse a maximum of greater than 150 times per pulsation, along with the directed interior of the pyrolysis reactor chamber. Energy dissipation across the wavelength may not be fully diminished until the single pulse has reflected over 50 times. These energy introductions along with the light hydrocarbon catalyst provides a molecular bond cohesion reduction by about 5-12 times, reducing overall time for the vaporization of the liquid plastic to a gaseous state phase, through the heated process, prior to entry into the pyrolysis chamber 141, with a heat increase upon entry into the pyrolysis reactor chamber 141 to greater than about 500° C. (932° F.) to less than about 550° C. (1022° F.). Typical reaction conversion time, prior to utilization of the pulsed catalyst system, was 180-minutes to about 300-minutes, conversion therapy of this state phase change from liquid to gaseous or vapor state utilizing the pulsed state catalyst is documented at about 15-minutes to about 25-minutes.

Returning to FIG. 1, when the liquid plastic has passed through the catalyst injection system 133, the liquid plastic enters the pyrolysis reactor chamber 141. The reactor 141 may be heated to a temperature of between about 300° C. to about 550° C. through conventional heating systems, such as steam augmentation, natural gas directed firing, diesel, and/or propane directed firing. Some examples of unconventional heating systems may be nuclear fission, nuclear fusion, electrolysis, induction heating, microwave, solar, and other such subsets. The heating systems may be consistent and efficient. In some aspects, the heating of the reactor 141 may be provided from an exhaust of a boiler 10 that is used to generate steam 8 for the phase converter 231, reactor 141, the steam-assisted heating system 12, and/or the preheating process 147. A process heat exchange unit (not shown) may exchange heat from the boiler and/or the reactor 141 for the phase converter 231, the steam-assisted heating system 12, and/or the preheating process 147. The use of the heat exchanger may reduce the amount of energy used by the system.

The pyrolysis reactor chamber 141 may have a limiter valve that allows a slight pressure to occur within the chamber. The chamber 141 may be substantially free of oxygen. The slight pressure may retain any pulsed energy within the chamber 141 and does not release the pulsed energy with the vapors that are being produced and harvested from a heated, energized plastic within the reactor chamber 141. The slight pressure may be in the range of approximately 1050-kPa to approximately 1400-kPa (150-PSI to 200-PSI). The reactor pressure may be up to 1750-kPa (250-PSI). A placement of the limiter valve may account for any reductions in the energy of the pulsed energy.

A condenser 185 may be fluidly coupled to a release outlet located at or near a top of the reaction chamber 141. Any hydrocarbon vapors generated within the reactor chamber 141 may travel through the release outlet and into the condenser 185. The condenser 185 may be leveled at initializing condensation and reforming of a liquid state hydrocarbon based in a range of a light grade oil capable of being processed. A condenser temperature range may be between about 70° C. to about 150° C. and a condenser pressure of less than 175-kPa (25-PSI). The condensed output may be provided to a distributor 129 that may separate the condensed output into gaseous hydrocarbons 6, light grade liquid hydrocarbons 37, and heavy grade liquid hydrocarbons 38. Secondary heating systems may also be used in the storage of the hydrocarbons, 47, 48, and the primary heating of the heavy hydrocarbon line 38, form the separation of the condenser 185, and pulling the heavy hydrocarbons off the bottom 43 of the reactor 141 over a period of time. In some capacity the heavy hydrocarbons may be considered char, in which a heavy hydrocarbon formation occurs, with formulations that are similar to, but not limited to bitumen and or asphaltenes.

Any gaseous hydrocarbons 6 may be collected and returned to a collection vessel 9 and then pressure pumped 18 into fueling heaters within the boiler 10 and/or the pyrolysis reactor 141 to reduce overall cost of the heating processes. This usage reduces an amount of inputted natural gas 1 from exterior sources. During initial testing, a small percentage of natural gas 6 was created by the process, in which only 2-3% of the overall volumetric of solid plastic 200 was converted. Resulting in 0.125 BOE (Barrels of Oil Equivalent) of the overall structured utilization of the solid plastic 200.

Any higher molecular chain hydrocarbons 38, which convert to a very viscous liquid may be stored in a heavy hydrocarbon storage 58. Transferring of light hydrocarbon liquids 37 may be stored in a liquid storage 47 with all venting closed to allow for any vented extraction of gaseous or light end hydrocarbons that can be used in the heat processes of the boiler 10 and/or reactor 141. In some aspects, the light hydrocarbon liquids 37 may be used by the catalyst injection system 133.

Heated processes that vent heat exhaust may be carbon captured though either carbon sequestration, a light vapor blanket, a bubble mitigation system to remove process, of carbon monoxide (CO), carbon dioxide (CO₂), and nitrous oxide (NOX). Carbon, or activated charcoal filters may be used to remove any remaining biproducts of combustion.

Once the waste, recyclable plastic enters into the pre-heat vat, that at this point until the end liquid light hydrocarbon is removed from the storage, that the entire system is considered either “closed” or “closed loop”, by way of meaning that natural venting systems, or natural migration of any vapors are no longer capable of occurring within this system as it directed to only point of removal.

In the cleaning of water 3 as described afore mentioned, multiple disciplines of cleaning including but not limited to mechanical, vibrational, air, electromagnetic, light, and heating may be used in the process to clean and recycle the water to ensure a true “closed loop system” and reduce the water input 2 into the cleaning process of the solid plastic process.

According to an aspect herein, the system for converting solid plastic to a base hydrocarbon may comprise: a energized pressure release utilizing a light hydrocarbon catalyst, a pyrolysis reactor in which a low oxygen state with a high heat utilized for the final cracking of the molecular chains, and condensation chambers that are temperate controlled to allow for molecular reconstruction at specific temperatures. The energized pressure release may be alternating, in repeat in a continuous manner. The energized pressure may be regulated and consistent and have a minimum and maximum regulated pressure. The energized pressure release may be designated at an angle of ascent directed to the primary axis of the tubular member, then is no less than 8-degrees and no more than 15-degrees. The energized pressure release may be generated at a minimum release of 8-15 Hz, provided at approximately 125 horsepower of energized pressure release calculated at the point of release. The catalyst may comprise a light liquid hydrocarbon pertaining to a C₁₆H₃₄, with the primary components being a light hydrocarbon, such as heavy diesel, oil, or other similar liquid hydrocarbon. The primary components of the catalyst may be derived from the primary source of light liquid hydrocarbon. The pyrolysis reactor may be conducted in an elongated tubular member. The pyrolysis reactor chamber may employ concave reflective surfaces within the end members of the chambers at either delineation ending of the elongated tubular member. The pyrolysis reactor liquid entry may be directed within a centralized entry within said concave reflective member. The pyrolysis reactor may have a primary heat source of relative consistent heating capabilities, with limited varying degrees. The condensation chambers may contain varying degrees and ranges of temperature to allow for multiple cooling and vapor condensing. The condensation chambers may have multiple stages through a variety of slotted and differing faced members for accumulation of the condensation for collection.

According to an aspect herein, the method for converting solid plastic into a baser hydrocarbon form may comprise: a solid plastic to phase shift to a liquid phase, through a heated system; a molecular bond destabilization of the liquid phase through applied energy pressure releases, directed, utilization of a light hydrocarbon; an enhanced vaporization rate within a pyrolysis reactor of up to 400%; a condensation rate to provide 95% liquid conversion. The solid plastic may comprises plastic 1-7, including post-consumer plastics, that may contain light organic contamination, light industrial contamination and is provided by recycling, solid waste reclamation and other municipalities. The method may removing contaminations of the plastics through means of mechanical, water, pressure, and heat. The solid plastic phase shift to liquid may be applied through steam heat and/or enhanced by other heated sources, such as natural gas. The liquid phase may be a thixotropic heated liquid that is movable along tubular members by pumping members for said movement. The energy pressure releases may comprise a liquid catalyst. The liquid catalyst may be a light liquid hydrocarbon. The light liquid hydrocarbon may be considered a seed molecule. The increased vaporization rate in the pyrolysis reactor may occur directly due to the molecular bond destabilization. The vaporization rate may be consistent within the reactor and may reflect operational limits from 300-600% increased conversion rates. The condensation rate may be 100% vaporization, consisting of condensation reorganization of 2-3% C₄₋₁₀H₈₋₁₄, 94-96% C₁₆₋₂₄H₁₈₋₃₂, 1-3% C₄₆₋₈₀H₅₀₋₈₂, variance of percentages may be a maximum of 20%. The secondary condensation formation may include O₂, formation through utilization of vaporization of water. The final products may be considered natural gas, “green” oil, and char, namely bitumen, asphaltene. The percentage of offset contamination may be less than 0.5% of volume, which includes water.

Varying degrees of steam may be used herein known as such terms as “wet” and “dry” steam. “Wet” steam utilization may occur in lower temperature applications with a rate of conversion of heat to heated source being very high. An example of utilization of this will be in the heating of wash water 2. “Dry” steam also known as super-heated steam, which is used in applications where condensed steam reduces the possible utilization of the heat values and transmission of steam. Once “dry” steam arrives on site the steam is then condensed and allowed to have a small amount of water “wet” to allow for the heat and energy transference. “Dry” steam utilization may be used in the pyrolysis reactor chamber 141 and/or the pre-heat vat 147.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

The above detailed description of the embodiments of the invention is not intended to be exhaustive or to limit the invention to the precise form disclosed above or to the field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention considering the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A system for converting a solid plastic to a base hydrocarbon, the system comprising:
a preheating chamber transforming the solid plastic into a liquid plastic;
at least one injector providing a focused energy release into the liquid plastic to break molecular bonds in the liquid plastic, wherein the focused energy release comprises a catalyst, the liquid plastic flowing by the at least one injector;
a pyrolytic reactor receiving the liquid plastic from the preheating chamber and further heating the liquid plastic to form the base hydrocarbon; and
a condenser receiving the base hydrocarbon and condensing the base hydrocarbon into at least one of: a light hydrocarbon liquid, a heavy hydrocarbon, and a natural gas.

2. The system of claim 1, wherein the at least one injector is directed at a focal refractor within a flow of the liquid plastic.

3. The system of claim 2, wherein the focal refractor is centrally located within the flow of the liquid plastic.

4. The system of claim 2, wherein the focal refractor comprises a plurality of fins extending radially from a central hub.

5. The system of claim 4, wherein the central hub comprises a reflective dish.

6. The system of claim 2, wherein the focal refractor transforms a laminar flow of the liquid plastic into a turbulent flow.

7. The system of claim 1, wherein the at least one injector is at an angle of between 8-degrees and 15-degrees in relation to a flow of the liquid plastic.

8. The system of claim 1, wherein the catalyst comprises a light liquid hydrocarbon selected from any one of: ethanol, methanol, naphtha, and light oil.

9. The system of claim 1, wherein at least a portion of the catalyst is from the base hydrocarbon.

10. A method for converting a solid plastic to a base hydrocarbon, the method comprises:
transforming the solid plastic into a liquid plastic by heat;
flowing the liquid plastic past at least one focused energy release to break molecular bonds in the liquid plastic, wherein the focused energy release comprises a catalyst;
heating the liquid plastic in a pyrolytic reactor to form the base hydrocarbon; and
condensing the base hydrocarbon into at least one of: a light hydrocarbon liquid, a heavy hydrocarbon, and a natural gas.

11. The method of claim 10, further comprises: directing the at least one focused energy release at a focal refractor within the flow of the liquid plastic.

12. The method of claim 11, wherein the focal refractor is centrally located within the flow of the liquid plastic.

13. The method of claim 12, wherein the focal refractor comprises a plurality of fins extending radially from a central hub.

14. The method of claim 13, wherein the central hub comprises a reflective dish.

15. The method of claim 11, further comprises transforming a laminar flow of the liquid plastic into a turbulent flow.

16. The method of claim 10, wherein the at least one injector is at an angle of between 8-degrees and 15-degrees in relation to a flow of the liquid plastic.

17. The method of claim 10, wherein the catalyst comprises a light liquid hydrocarbon selected from any one of: ethanol, methanol, naphtha, and light oil.

18. The method of claim 10, wherein at least a portion of the catalyst is from the base hydrocarbon.
